(19) United States
(12) Patent Application Publication
(10) Pub. No.: US 2011/0162150 A1
(43) Pub. Date: Jul. 7, 2011

(54) Hand tool

(75) Inventors: Xingjiang Yu, Wendeng (CN); Shigang Li, Wendeng (CN)

(73) Assignee: Wendeng Maxpower Adanced Tool Company Ltd.

(21) Appl. No.: 12/655,659

(22) Filed: Jan. 4, 2010

(51) Int. Cl. B25F 1/00; B25B 23/00

(52) U.S. Cl. 7/139; 81/179

(57) ABSTRACT

A hand tool includes a wrench handle and a multi-functional arrangement, which includes a wrench head having a sliding channel to define an opened end, a closed end, and a top opening, a fixed jaw integrally extended from the wrench head, an adjustable gripping member, a rotatable adjustor, and a hollow hammer head. The adjustor is rotatably coupling with the gripping member, which is being received in the sliding channel and extended through the top opening to align with the fixed jaw, to reciprocally drive the adjustable jaw at a fully closed position and a fully opened position. The hammer head is integrally formed at the closed end of the wrench head as an added function of the wrench without altering the original shape of the hand tool, so as to minimize the overall size without compromising the structural strength and the manufacturing cost.

### BACKGROUND OF THE PRESENT INVENTION

1. Field of Invention

The present invention relates to a hand tool, and more particularly to a hand tool which not only provides an adjustable wrench for applying mechanic torque force to turn a fastener, such as a bolt or a nut, but also integrates with a hammer structure for providing a hammer effect of the adjustable wrench.

2. Description of Related Arts

The traditional hand tool, such as a wrench, is widely applied for enhancing the mechanical torque force, so that a user is able to comfortably turn a bolt or other objects designed for interface with the wrench. Generally, the hand tool for rotatably turning the bolts has elongated body having a mounting head at one end portion for steadily coupling with the bolt, and the other end portion for being held by a hand of the user, so that the elongated body of the hand tool provides a relatively larger torque force for turning the bolts or the likes.

In order to match variety of dimensions of bolts or the likes, there is an adjustable wrench hand tool in the existing market, wherein the adjustable wrench hand tool is able to select the opening size of the mounting head to detachably engaging with the bolt, so as to apply the torque force thereon via the adjustable wrench hand tool. Take a desk for example, the larger sized bolt is used in the connection between a table top and the pedestals, and a smaller sized bolt is used for the feet rest affixing onto the pedestals, so that the adjustable wrench hand tool provides a universal hand tool for interface with the different sized bolts.

Therefore, there is no need for preparing, buying, or carrying a bunch of different sized wrench hand tools in order to fittedly and detachably engaging the mounting head of the wrench hand tool with variety sizes of bolts. Furthermore, the adjustable wrench hand tool also minimizes the inconvenience of changing the traditional auxiliary hand tools for different sized bolts while assembling the parts of a product.

Still, there are some main concerns regarding the drawbacks of the existing hand tools. Firstly, the wrench like hand tools can only provide a single function of turning the bolts. During any constructions or assembling process, there may have a plurality of steps, such as turning bolts, hammering, nailing, pulling out bolts, and screwing screws, etc. Each of the steps may require different hand tools to complete the work, and each of the steps may also require two or more hand tools involved therein. Therefore, it is exhausted for the user keep switching the hand tools during the construction or assembling process.

It may turn out that many of the hand tools, each of which may be heavy in weight and bulky, have to be carried at the same time to a predetermined location for construction or assembling process. Take a traditional adjustable open-end wrench for turning the bolts for example. Normally, when the user is applying the wrench to turn the bolt of the fastener into an object, a hammer might be needed for firstly hammering the bolt for delivering an impact thereon, and then rotatably inserting the bolt through an assembled part of the object. It is a common technique for using the wrench hand tool along with the hammer. Thus, both of the hammer and the wrench hand tool, having predetermined weight which is heavy enough for applying the impact or rotation force on the fastener, are commonly required in one single steps of assembling.

In addition, the adjustable open-end wrench normally has a movable jaw for adjustably engaging with the bolts, so that the handle portion of the wrench is able to engage with different sized bolts to drive thereof. The movably adjustable opening of the jaw normally has a rotation axis coupling therewith, wherein the rotation axis is driven by an actuator via the threads on the rotation axis and the actuator respectively. In order to stably drive the rotation axis, the rotation axis tends to have an elongated rotation axis to protruding out of both two end of a slot rotatably coupling with and guiding the elongated rotation axis. In other words, the elongated rotation axis has a predetermined length to ensure the rotation axis movably coupling with two openings of the two end of the slot all the time, so as to stably support and guild the rotation axis via the slot. The protruding portion of the two end of the rotation axis not only increase the safety issue while working with the wrench hand tool, but also increase the overall volume of wrench hand tool.

### SUMMARY OF THE PRESENT INVENTION

A main object of the present invention is to provide a hand tool, which is able to combine two or more functions in the single hand tool.

Another object of the present invention is to provide a hand tool, which provides a multi-functional wrench hand tool without substantially altering the original structure and without compromise the strength of the hand tool.

Another object of the present invention is to provide a hand tool, wherein the hollow hammer head is able to deliver an impact effect on an object while using the wrench function of hand tool.

Another object of the present invention is to provide a hand tool, wherein the hollow hammer head is integrally formed at the wrench head without substantially altering the original shape of the hand tool.

Another object of the present invention is to provide a hand tool, wherein the hammer face of the hollow hammer head is matted flat surface to enhance the friction and a trapezoid shape, such that the hammer head is able to efficiently deliver the impact force.

Another object of the present invention is to provide a hand tool, wherein the elongated sliding member of the adjustable gripping member has a minimized length without compromising the structural strength of the hand tool.

Another object of the present invention is to provide a hand tool, wherein the reinforcing member of the adjustable jaw and the strengthen member enhance the structural strength of the multi-functional wrench head.

Accordingly, in order to accomplish the above objects, the present invention provides a hand tool, which comprises an elongated wrench handle and a multi-functional wrench arrangement.

The multi-functional wrench arrangement comprises a wrench head, a fixed jaw an adjustable gripping member, and a rotatable adjustor.

The wrench head has a sliding channel defining an opened end, an opposed closed end, and a top opening, and integrally extended from the wrench handle. The fixed jaw, having a first fixed face, is integrally extended from the wrench head at the closed end of the sliding channel. The adjustable gripping member comprises an to elongated sliding member selectively sliding along the sliding channel, and an adjustable jaw, having a first adjustable face parallel to the first fixed face, integrally extended from the sliding member through the top opening of the sliding channel. The rotatable adjustor is rotatably coupling at the wrench head to drive the adjustable gripping member between a fully opened position and a fully closed position.

The multi-functional wrench arrangement further comprises a hollow hammer head integrally extended from the wrench head to define the closed end of the sliding channel within the wrench head. The hammer head has a hammer face integrally formed at a peripheral surface of the wrench head to provide an added function of the wrench head.

Accordingly, at the fully opened position, a first end of the sliding member is slid out of the opened end of the sliding channel to maximize a distance between the first fixed face and the first adjustable face. At the fully closed position, a second end of the sliding member is slid to be enclosed within the closed end of the sliding channel at a position that the first adjustable face is alignedly overlapped with the first fixed face.

Therefore, the hollow hammer head formed at the closed end not only provides the added function to the wrench head, but also provides a predetermined hollow space within the closed end, so that when the sliding member is slid at the fully closed position, the second end of the sliding member having a minimized predetermined length is being enclosed without any protrusion protruded out of the closed end of the sliding channel at the wrench head.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a hand tool according to a preferred embodiment of the present invention.

FIG. 2 is a perspective view of the wrench head of the hand tool according to the above preferred embodiment of the present invention.

FIG. 3 is a sectional view of the hand tool according to the above preferred embodiment of the present invention, illustrating an adjustable jaw at a fully opened position.

FIG. 4 is sectional view of the hand tool according to the above preferred embodiment of the present invention, illustrating the adjustable jaw at a fully closed position.

FIG. 5 is side view of the hand tool according to the above preferred embodiment of the present invention, illustrating a hummer face of a hammer head.

### DETAILED DESCRIPTION OF THE PREFERRED EMBODIMENT

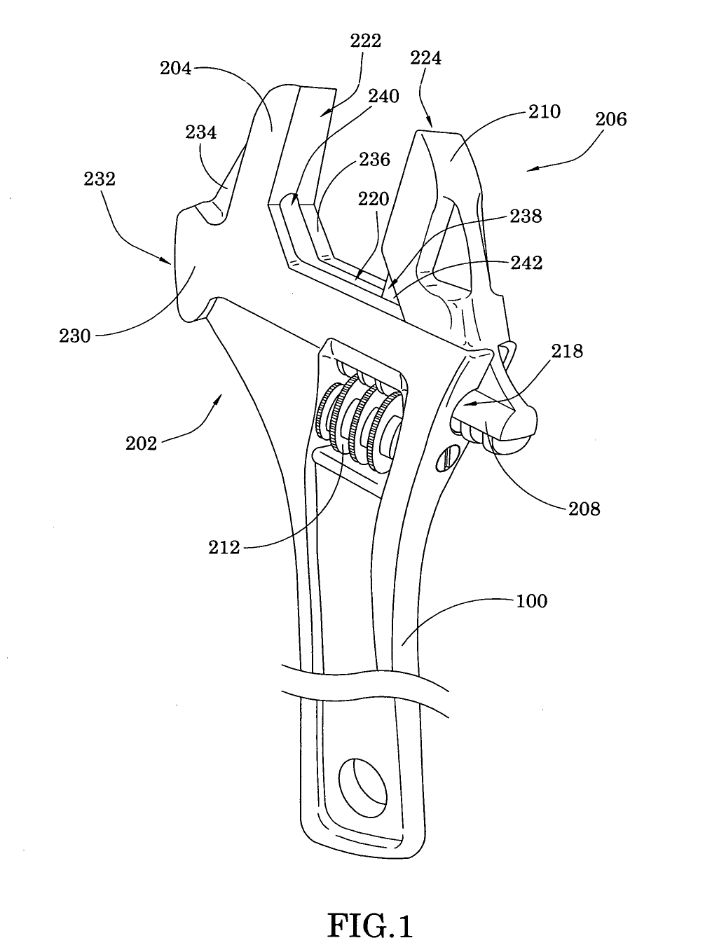

Referring to FIGS. 1 to 5 of the drawings, a hand tool according to a preferred embodiment of the present invention is illustrated, wherein the hand tool comprises an elongated wrench handle 100 and multi-functional wrench arrangement 200, which comprises a wrench head 202 integrally extended from the wrench handle 100.

The wrench head 202 has a sliding channel 214 defining a closed end 216, an opposed opened end 218, and an elongated top opening 220.

The multi-functional wrench arrangement 200 further comprises a fixed jaw 204 extended from the wrench head 202, an adjustable gripping member 206, and a rotatable adjustor 212.

The fixed jaw 204 is upwardly extended from the wrench head 202 at the closed end 218 of the sliding channel 214, wherein the fixed jaw 204 has first fixed face 222 facing towards the opened end 218 of the sliding channel 214.

The adjustable gripping member 206 comprises an elongated sliding member 208 reciprocally sliding along the sliding channel 214 and an adjustable jaw 210 integrally and upwardly extended from the elongated sliding member 208 through the top opening 220 of the sliding channel 214. The adjustable jaw 210 has a first adjustable face 224, wherein the first fixed face 222 of the fixed jaw 204 is preferably parallel to the first adjustable face 224 of the adjustable jaw 210. Therefore, a fastener, such as a hexagon bolt, is able to be stably gripped between the first fixed face 222 and adjustable face 224, so as to apply a torque force to turn the fastener via the wrench handle 100.

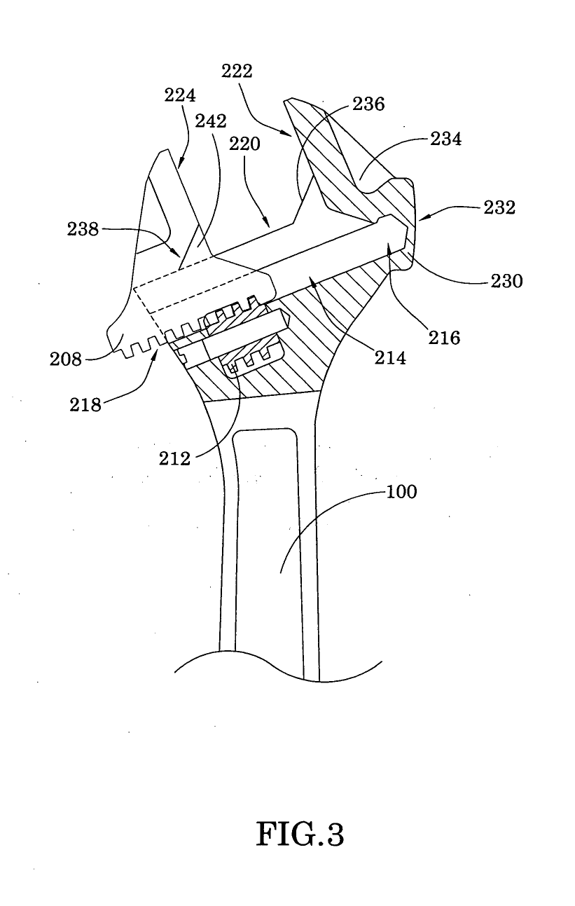

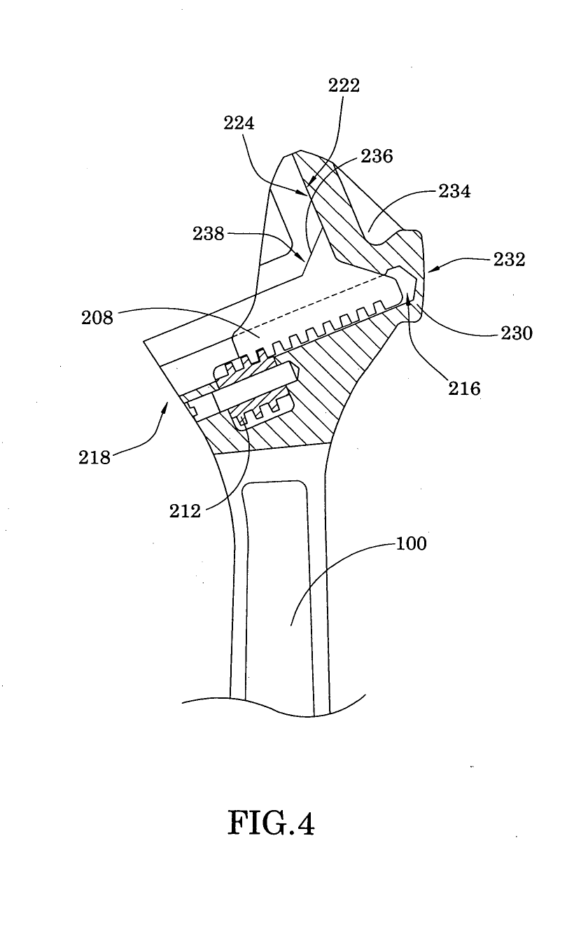

The rotatable adjustor 212 is rotatably coupled at the wrench head 202 to adjust the adjustable gripping member 206 between a fully opened position and a fully closed position as shown in FIGS. 3 and 4 respectively. Accordingly, the rotatable adjustor 212 is rotatably coupling with the elongated sliding member 208 to drive the adjustable jaw 210 of the gripping member 206 moving toward the fixed jaw 204 to the fully closed position and away from the fixed jaw 204 until stopped at the fully opened position.

Accordingly, the elongated sliding member 208 has a plurality of engaging teeth integrally formed at a bottom side of the sliding member 208, wherein the rotatable adjustor 212 has an outer threads in accordance with the engaging teeth of the elongated sliding member 208, such that the rotatable adjustor 212 is reciprocally and rotatably driving the elongated sliding member 208 between the fully opened position and closed position. At the fully opened position, a first end 226 of the sliding member 208 is slid out of the opened end 218 of the sliding channel 214 to maximize a distance between the first fixed face 222 and the adjustable face 224. At the fully closed position, a second end 228 of the sliding member 208 is slid to enclose within the closed end 216 of the sliding channel 214 at a position that the first adjustable face 224 is alignedly overlapped with the first fixed face 222.

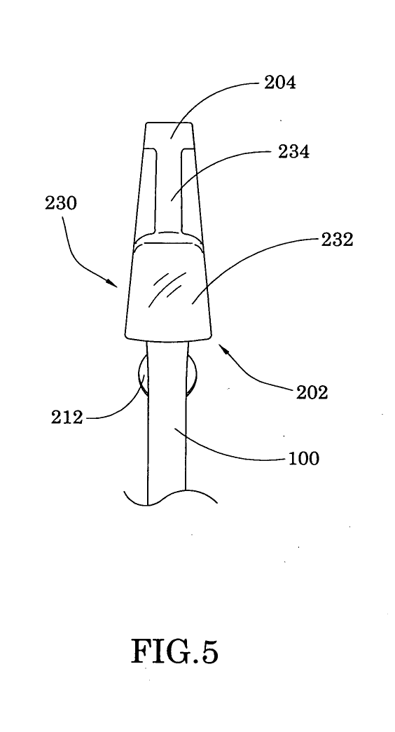

The multi-functional wrench arrangement 200 further comprises a hollow hammer head 230 integrally extended from the wrench head 202 to define the closed end 216 of the sliding channel 214 within the hammer head 230, as shown in FIG. 5, wherein the hammer head 230 has a hammer face 232 integrally formed at a peripheral surface of the wrench head 202 to provide an added function of the wrench head 202, so as to the minimize the overall size of the hand tool at both fully opened and closed positions of the adjustable gripping member 206.

Therefore, the hollow hammer head 230 formed at the closed end 216 not only provides the added function to the wrench head 202, but also provides a predetermined hollow space within the closed end 216, so that when the sliding member 208 is slid at the fully closed position, the second end 228 of the sliding member having a minimized predetermined length is being enclosed without any protrusion protruded out of the closed end 216 of the sliding channel 214 at the wrench head 202.

As will be appreciated that the sliding member 208 is reciprocally slid within the sliding channel 214 without protruded out of the closed end 230 and is reduced and minimized the volume of the wrench head 202, so that the wrench handle 100 is able to incorporate in a relatively narrower working space to rotatably drive the wrench head 202 to rotate, so as to easily turn the fastener.

Accordingly, the hammer face 232 of the hammer head 230 is preferably a trapezoid shape integrally formed with the wrench head 202. In other words, the trapezoid shaped hammer face 232 has a width gradually increased from top to bottom of the hammer head 230. Therefore, the trapezoid shaped hammer face 232 provides a relatively larger force applying surface of the hammer head 230 without substantially altering the structure of the wrench head 202, so as to minimize the material for forming the add-on extra hammer function to the wrench head 202 of the multi-functional wrench arrangement 200. It is appreciated that the hammer head 230 integrally formed at the closed end 216 of the sliding channel 214 has substantially no protruding portion protruded out of the wrench head 202, so as to minimize the volume of the wrench head 202.

In addition, the hammer face 232 of the hammer head 230 preferably has a matted flat surface for enhancing a friction thereof, so as to conveniently deliver an impact to an object. In order to efficiently deliver the impact force on the object, the matted flat surface of the hammer face 232 is preferred to substantially parallel to an axis of the elongated wrench handle 100. It is worth to mention that the added hollow hammer head 230 does not substantially altering the whole structure of the wrench head 202, and automatically apply the weight of the wrench head 202 itself to be a hammer function, so as to minimize the manufacturing cost.

As described above, the wrench head 202 further comprises a strengthen member 234 integrally extended from the fixed jaw 204 to the wrench head 202 for substantially transmitting the impact force at the hammer face 232 of the hammer head 230 to the wrench head 202. Accordingly, the strength member 234 has a width smaller than each of the fixed jaw 204 and the hammer head 230, such that the strength member 234 is able to enhance the structural strength of the wrench head 202 while minimizing the material of the hand tool.

The fixed jaw 204 further has a second fixed face 236 inclinedly extended from the first fixed face 222 of the fixed jaw 204. The adjustable jaw 210 further has a second adjustable face 238 inclinedly extended from the elongated sliding member 208 to the first adjustable face 224 of the adjustable jaw 210. Thus, the second fixed face 236 and the second adjustable face 238 are arranged in such a manner that when the adjustable gripping member 206 is slid at the fully closed position, the second adjustable face 238 is alignedly overlapped with the second fixed face 236.

Accordingly, the inclined second fixed face 236 is preferably formed an angle of 120° between the first fixed face 222 and second fixed face 236, so that the fastener, especially the hexagonal bolt, is able to be firmly gripped between the fixed jaw 204 and the adjustable jaw 210, so as to prevent the fastener slipped out of the wrench head 202 of the hand tool while applying the torque force to turn the fastener via the hand tool.

The fixed jaw 204, which is upwardly extended on the wrench head 202, further has a communication slot 240 integrally formed at the wrench head 202 to communicate with the top opening 220 of the sliding channel 214, wherein the communication slot 240 has the same width of the top opening 220 of the sliding channel 214, so that the communication slot 240 is integrally and continuously formed with the top opening 220 of the sliding channel 214.

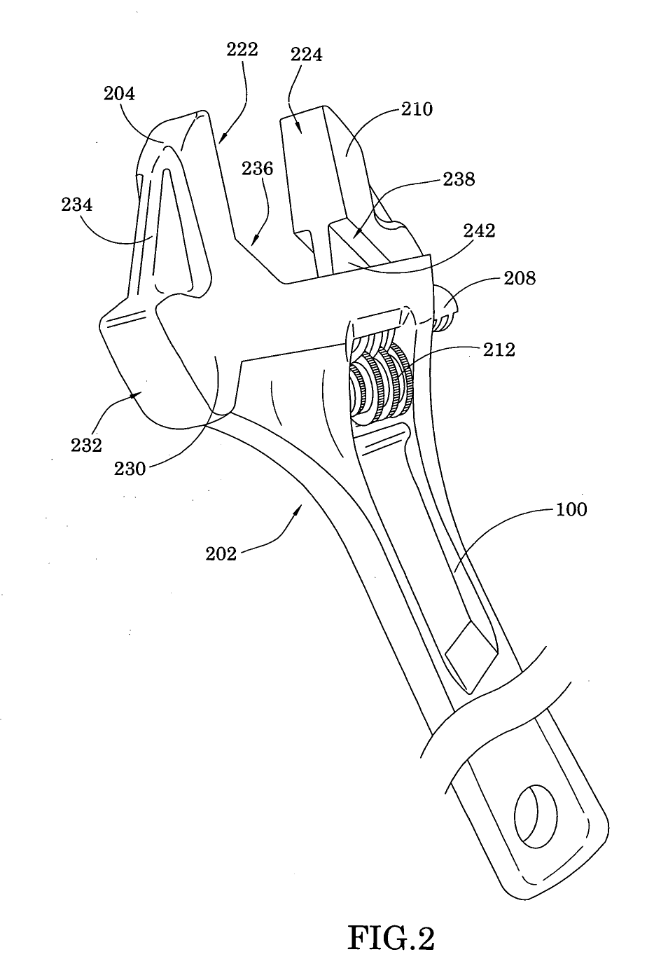

As shown in FIG. 2, the adjustable gripping member 206 further comprises a reinforcing member 242 integrally extended from the sliding member 208 to the second adjustable face 238 of the adjustable jaw 210. The reinforcing member 242 has a width corresponding to the communication slot 240, so that the reinforcing member 242 is able to be slidably received within the communication slot 240, so as to enhance the stability of the adjustable jaw 210 while reciprocally sliding along the sliding channel 214.

In other words, the reinforcing member 242 has a width smaller than the width of the adjustable jaw 210, so that when the adjustable gripping member 206 is slid at the fully closed position, the reinforcing member 242 is received within the communication slot 240 to alignedly overlap the second adjustable face 238 with the second fixed face 236 of the fixed jaw 204. It is appreciated that the reinforcing member 242 enhances the stability of the adjustable jaw 210 while the adjustable gripping member 206 is reciprocally slid along the sliding channel 214, so that the elongated sliding member 208 is able to minimize its length to provide the closed end 216 of the sliding channel 214 without substantially reducing the structural strength of the adjustable gripping member 206, so as to minimize the overall size of the wrench head 202.

It is worth to mention that an angle between the sliding channel 214 of the wrench head 202 and the axis of the wrench handle 100 is preferably larger than 90°, such that the wrench handle 100 is able to provide a relatively more efficient torque force on the fastener via the wrench head 202.

As will be readily appreciated by one skilled in the art, the wrench hand tool with the hammer head 230 of the multi-functional wrench arrangement 200 prevents carrying a bunch of hand tools during an assembling process, since hammer is commonly used with the wrench hand tool. The hollow hammer head 230 is provided as an added function to the wrench head 202 without substantially altering the structure of the hand tool. Without substantially protruded portion of the hollow hammer head via integrally formed at the closed end 216 of the sliding channel 214, no protruding portion at the fully closed position of the adjustable gripping member 206, and the arrangement of reinforcing member 242 and strength member 234, the present invention provides a minimum manufacturing cost and overall size without compromise the structural strength of the hand tool.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A hand tool, comprising:
an elongated wrench handle; and
a multi-functional wrench arrangement, comprising:
a wrench head integrally extended from said wrench handle, wherein said wrench head has a sliding channel defining a closed end, an opposed opened end, and an elongated top opening;
a fixed jaw, having a first fixed face, integrally extended from said wrench head at said closed end of said sliding channel;
an adjustable gripping member comprising an elongated sliding member selectively sliding along said sliding channel, and an adjustable jaw, having a first adjustable face parallel to said first fixed face, integrally extended from said sliding member through said top opening of said sliding channel;
a rotatable adjustor rotatably coupled at said wrench head to drive said adjustable gripping member between a fully opened position and a fully closed position, wherein at said fully opened position, a first end of said sliding member is slid out of said opened end of said sliding channel to maximize a distance between said first fixed face and said first adjustable face, and at said fully closed position, a second end of said sliding member is slid to enclose within said closed end of said sliding channel at a position that said first adjustable face is alignedly overlapped with said first fixed face; and
a hollow hammer head integrally extended from said wrench head to define said closed end of said sliding channel within said hammer head, wherein said hammer head has a hammer face integrally formed at a peripheral surface of said wrench head to provide an added function of said wrench head.

2. The hand tool, as recited in claim 1, wherein said hammer head has a trapezoid shape that a width of said hammer face is gradually increasing from top to bottom.

3. The hand tool, as recited in claim 1, wherein said hammer face of said hammer head is a matted flat surface for enhancing a friction thereof.

4. The hand tool, as recited in claim 2, wherein said hammer face of said hammer head is a matted flat surface for enhancing a friction thereof.

5. The hand tool, as recited in claim 1, wherein a planar direction of said hammer face of said hammer head is parallel to an axis of said wrench handle.

6. The hand tool, as recited in claim 2, wherein a planar direction of said hammer face of said hammer head is parallel to an axis of said wrench handle.

7. The hand tool, as recited in claim 4, wherein a planar direction of said hammer face of said hammer head is parallel to an axis of said wrench handle.

8. The hand tool, as recited in claim 1, wherein said wrench head further comprises a strengthen member integrally extended from said fixed jaw to said hammer head for substantially transmitting an impact force at said hammer face to said wrench head, wherein said strengthen member has a width smaller that each of said fixed jaw and said hammer head.

9. The hand tool, as recited in claim 4, wherein said wrench head further comprises a strengthen member integrally extended from said fixed jaw to said hammer head for substantially transmitting an impact force at said hammer face to said wrench head, wherein said strengthen member has a width smaller that each of said fixed jaw and said hammer head.

10. The hand tool, as recited in claim 7, wherein said wrench head further comprises a strengthen member integrally extended from said fixed jaw to said hammer head for substantially transmitting an impact force at said hammer face to said wrench head, wherein said strengthen member has a width smaller that each of said fixed jaw and said hammer head.

11. The hand tool, as recited in claim 1, wherein said fixed jaw further has a second fixed face inclinedly extended from said first fixed face, wherein said adjustable jaw further has a second adjustable face inclinedly extended from said second adjustable face and arranged in such a manner that when said adjustable gripping member is slid at said fully closed position, said second adjustable face is alignedly overlapped with said second fixed face.

12. The hand tool, as recited in claim 7, wherein said fixed jaw further has a second fixed face inclinedly extended from said first fixed face, wherein said adjustable jaw further has a second adjustable face inclinedly extended from said second adjustable face and arranged in such a manner that when said adjustable gripping member is slid at said fully closed position, said second adjustable face is alignedly overlapped with said second fixed face.

13. The hand tool, as recited in claim 10, wherein said fixed jaw further has a second fixed face inclinedly extended from said first fixed face, wherein said adjustable jaw further has a second adjustable face inclinedly extended from said second adjustable face and arranged in such a manner that when said adjustable gripping member is slid at said fully closed position, said second adjustable face is alignedly overlapped with said second fixed face.

14. The hand tool, as recited in claim 11, wherein said fixed jaw, which is upwardly extended on said wrench head, has a communication slot formed along said second adjustable face to communicate with said top opening of said sliding channel, wherein said communication slot has the same width of said top opening of said sliding channel.

15. The hand tool, as recited in claim 12, wherein said fixed jaw, which is upwardly extended on said wrench head, has a communication slot formed along said second adjustable face to communicate with said top opening of said sliding channel, wherein said communication slot has the same width of said top opening of said sliding channel.

16. The hand tool, as recited in claim 13, wherein said fixed jaw, which is upwardly extended on said wrench head, has a communication slot formed along said second adjustable face to communicate with said top opening of said sliding channel, wherein said communication slot has the same width of said top opening of said sliding channel.

17. The hand tool, as recited in claim 14, wherein said adjustable gripping member further comprises a reinforcing member integrally extended from said sliding member to said second adjustable face of said adjustable jaw, wherein said reinforcing member has a width corresponding to said communication slot such that when said adjustable gripping member is slid at said fully closed position to alignedly overlap said second adjustable face with said second fixed face, said reinforcing member is slidably received within said communication slot.

18. The hand tool, as recited in claim 15, wherein said adjustable gripping member further comprises a reinforcing member integrally extended from said sliding member to said second adjustable face of said adjustable jaw, wherein said reinforcing member has a width corresponding to said communication slot such that when said adjustable gripping member is slid at said fully closed position to alignedly overlap said second adjustable face with said second fixed face, said reinforcing member is slidably received within said communication slot.

19. The hand tool, as recited in claim 16, wherein said adjustable gripping member further comprises a reinforcing member integrally extended from said sliding member to said second adjustable face of said adjustable jaw, wherein said reinforcing member has a width corresponding to said communication slot such that when said adjustable gripping member is slid at said fully closed position to alignedly overlap said second adjustable face with said second fixed face, said reinforcing member is slidably received within said communication slot.

20. The hand tool, as recited in claim 13, wherein an inclination angle between said first and second fixed faces is 120°.

21. The hand tool, as recited in claim 16, wherein an inclination angle between said first and second fixed faces is 120°.

22. The hand tool, as recited in claim 19, wherein an inclination angle between said first and second fixed faces is 120°.
